(19) United States
(12) Patent Application Publication
(10) Pub. No.: US 2006/0039296 A1
(43) Pub. Date: Feb. 23, 2006

(54) Transmitting data in a wireless communications network

(76) Inventors: Masatoshi Nakamata, Espoo (FI); Tuomas Hakuli, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/979,098

(22) Filed: Nov. 2, 2004

Related U.S. Application Data
(60) Provisional application No. 60/602,311, filed on Aug. 18, 2004.

(51) Int. Cl. H04J 1/16

(52) U.S. Cl. 370/252; 370/335

(57) ABSTRACT

This invention relates to a communications system comprising a plurality of radio network controllers, at least one of said radio network controllers providing a controlling radio network controller function, wherein said controlling radio network controller is prohibited from causing reconfiguration of a communication parameter between user equipment and said radio network controller.

### BACKGROUND OF THE INVENTION

1. Field of the Invention

The present invention relates to transmitting data in a wireless communications network.

2. Related Art

Packets can be transmitted via the HSDPA (High Speed Downlink Packet Access) protocol implemented in a 3GPP (third generation partnership project) wideband code division multiple access (WCDMA) mobile telecommunications network.

High speed downlink packet access is a concept within WCDMA specifications whose main target is to increase user peak data rates and quality of service and to generally improve spectral efficiency for downlink asymmetrical and bursty packet data services. HSDPA has a short transmission time interval TTI, adaptive modulation and coding AMC, multicode transmission, fast physical layer (L1) hybrid automatic repeat request (H-ARQ) and uses a packet scheduler in a Node B or base station where it has easy access to air interface measurements. HSDPA makes use of this by adjusting the user data rate to match the instantaneous radio channel conditions. While connected, an HSDPA user equipment periodically sends a channel quality indicator (CQI) to the Node B or base transceiver station indicating what data rate the user equipment can support under its current radio conditions. The user equipment sends an acknowledgement for each packet so that the Node B knows when to initiate retransmission. With channel quality measurements available for each user equipment in the cell, the packet scheduler may optimise its scheduling amongst its users and thus divide the available capacity according to the running services and requirements.

In the controlling radio network controller CRNC a decision is made as to the scrambling code used for HSDPA transmission in the cell belonging to the RNC. If there are two RNCs involved for HSDPA transmission, the drifting RNC will inform the serving RNC the scrambling code used for the HSDPA using a radio network subsystem application part RNSAP message. The configuration for the scrambling code used for the HSDPA in the cell is enabled by the node B application part NBAP physical shared channel reconfiguration procedure. The 3GPP technical specification TS25.433 which defines the NBAP specification allows the CRNC to reconfigure the scrambling code used for the HSDPA in the cell even in the case where HS-PDSCH (high speed physical downlink shared channel) or HS-SCCH (high speed shared control channel) transmission is on going in the cell.

In order to reconfigure the scrambling code in the cell where two RNCs are involved in the HSDPA data delivery, there are two known scenarios for these procedures.

In this regard, reference is made to FIG. 1 which shows the message flow in this first scenario. In the first step S1, the drifting RNC (DRNC) 4 sends a message to the serving RNC (SRNC) 2. This is an RNSAP message which is RADIO LINK PARAMETER UPDATE with an HS-SCCH code change indicator IE Information element.

In step S2, the serving RNC 2 sends a message to the DRNC 4. This is an RNSAP message which is RADIO LINK RECONFIGURATION PREPARE with the HS-SCCH code change grant IE.

In step S3, the controlling/drifting C/DRNC sends a message to the Node B. This is an NBAP message which is a PHYSICAL SHARED CHANNEL RECONFIGURATION REQUEST which includes the HS-PDSCH and HS-SCCH scrambling code IE and SFN system frame number IE.

In step S4, Node B replies to the C/DRNC 4. This is an NBAP message and is a PHYSICAL SHARED CHANNEL RECONFIGURATION RESPONSE.

In step S5, the DRNC 4 sends a message to the SRNC 2 which is an RNSAP message. This is RADIO LINK RECONFIGURATION READY and includes the HS-PDSCH and HS-SCCH scrambling code IE.

In step S6, the SRNC 2 sends to the DRNC 4 a RNSAP message. This is a RADIO LINK RECONFIGURATION COMMIT with CFN connection frame number IE.

In step S7, the SRNC 2 sends to the user equipment 8 a RRC radio resource control message which is a PHYSICAL CHANNEL RECONFIGURATION REQUEST.

In step S8, the user equipment 8 replies to the SRNC 2 with an RRC message. This is the PHYSICAL CHANNEL RECONFIGURATION RESPONSE.

Finally, in step S9, after the CFN has elapsed, the HS-SCCH/HS-PDSCH transmission using the reconfigured scrambling codes starts.

However, this signalling flow has some problems. In order to reconfigure the channelisation codes for the HS-SCCH the HS-SCCH code change indicator IE was introduced in the RNSAP RADIO LINK PARAMETER UPDATE. It should be appreciated that the channelisation code is used for spreading whilst the scrambling code is used for scrambling. In principle, the scrambling code is allocated to one cell so that all UE in the cell have same scrambling code. It is used to distinguish cell. The channelisation code is allocated to DL physical channel of one UE. There is a need to include reconfiguration of scrambling code in the IE or to introduce a new IE indicating the request for reconfiguration of the scrambling code. With the current proposals, the scrambling code can be changed in step S5 as this message has an IE for the scrambling code. In other words the DRNC is able to change the scrambling code after the reception of RADIO LINK RECONFIGURATION PREPARE with HS-SCCH Code Change Indicator IE in step S4.

However, the usage of the IE “HS-SCCH Code Change Indicator” is against the original purpose of the IE. The IE indicates the permission to change channelization code only, but the DRNC is able to set the reconfigured scrambling code in HS-PDSCH and HS-SCCH Scrambling Code in RL RECONFIGURATION READY.

A second problem is that after the D/CRNC completes the NBAP physical shared channel reconfiguration procedure, if the SRNC wants to cancel the prepared reconfiguration, there is no procedure for the SRNC or CRNC to cancel the reconfiguration prepared by the NBAP physical shared channel reconfiguration procedure in the D/CRNC.

A further problem is that the SRNC decides the CFN in the RNSAP RADIO LINK RECONFIGURATION COMMIT but the SRNC does not have any information regarding the SFN included in the NBAP PHYSICAL SHARED CHANNEL RECONFIGURATION REQUEST. This causes the disadvantage of the timing of the scrambling code reconfigured by the SRNC is different from the timing of the scrambling code reconfigured by Node B. In practice this means that the SFN times the new configuration for Node B and the CFN independently times the new configuration for the SRNC.

Reference is now made to FIG. 2 which shows the signal flow in a second known scenario.

Steps T1 and steps T2 correspond respectively to steps S1 to S2 of FIG. 1.

In step T3, the D/CRNC replies to the SRNC 2 a RNSAP message-RADIO LINK RECONFIGURATION READY. This contrasts with the first scenario where the D/CRNC executes a NBAP: PHYSICAL SHARED CHANNEL RECONFIGUREATION REQUEST after reception of RNSAP message

In step T4, the SRNC 2 sends to the D/CRNC with a RNSAP message RADIO LINK RECONFIGURATION COMMIT with a CFN IE.

Step T5 corresponds to step S3, step T6 to step S4, Step T6, and Steps T7 to T9 to steps S7 to T9.

However, this scenario also has problems.

This scenario has the same first problem as outlined in relation to the scenario should in FIG. 1.

Where there is only one SRNC, there is not a great complexity for the D/CRNC to decide the SFN in the NBAP physical shared channel reconfiguration request. However, where there are multiple SRNCs involved, there are multiple CFNs and there is no mechanism for selecting the most appropriate SFN. This can lead to the unsynchronised status that the UE does not receive any HSPDA packets since the timing to change the scrambling codes is different between the various SRNCs and the Node B.

In scenario 2, the D/CRNC decides the SFN based on CFN received in step T4. This contrasts with scenario 1 where at the time(step S3) the D/CRNC executes NBAP:PHSYICAL SHARED CHANNEL RECONFIGURATION, DRNC/CRNC has not received the CFN that the SRNC wants to change. Therefore, in scenariol, D/CRNC is able to decide the SFN without any consideration of the SRNC. In the worst case scenario, it causes the situation that CFN set in the RNSAP message RADIO LINK RECONFIGURATION COMMIT from one SRNC has elapsed before the reception of the RNSAP RADIO LINK CONFIUGRATION COMMIT from another SRNC.

Another problem is that if the Node B rejects the NBAP physical shared channel reconfiguration procedure by sending the NBAP PHYSICAL SHARED CHANNEL RECONFIGURATION FAILURE, the scrambling code used for the HS-PDFCH/HS-SCCH in Node B and the one used in SRNC become different because the D/CRNC has no means to inform the SRNC of the failure.

It is an aim of embodiments of the present invention to address one or more of the above described problems.

### SUMMARY OF THE INVENTION

According to a first aspect in the present invention, there is provided a communications system comprising a plurality of radio network controllers, at least one of said radio network controllers providing a controlling radio network controller function, wherein said controlling radio network controller is prohibited from causing reconfiguration of a communication parameter between user equipment and said radio network controller.

According to a second aspect in the present invention, there is provided a radio network providing a controlling radio network controller function, wherein said controlling radio network controller is prohibited from causing reconfiguration of a communication parameter between user equipment and said radio network controller.

According to a third aspect in the present invention, there is provided a method of communication in a system comprising a plurality of radio network controllers, at least one of said radio network controllers providing a controlling radio network controller function, said method comprising the step of prohibiting said controlling radio network controller from causing reconfiguration of a communication parameter between user equipment and said radio network controller.

Accordingly to a fourth aspect in the present invention, there is provided a method of changing a communication parameter comprising the steps of sending a message from a drifting radio network controller to a serving network controller of a requirement to change a communication parameter and sending a request from said serving radio network controller to said drifting radio network controller requesting the drifting radio network controller change said communication parameter.

According to a fifth aspect in the present invention, there is provided a communication system comprising a drifting radio network controller and a serving radio network controller, said drifting radio network controller being arranged to send a message to a serving network controller of a requirement to change a communication parameter and said serving radio network controller being arranged to sending a request to said drifting radio network controller requesting the drifting radio network controller change said communication parameter.

According to a sixth aspect in the present invention, there is provided a drifting radio network controller arranged to send a message to a serving network controller of a requirement to change a communication parameter and in response to a request from said serving network controller to provide timing information to control timing of the change of said communication parameter.

According to a seventh aspect in the present invention, there is provided a serving radio network controller being arranged to sending a request to a drifting radio network controller requesting the drifting radio network controller change a communication parameter and to reconfigure said communication parameter in accordance with timing information received from said drifting radio network controller.

According to another aspect in the present invention, there is provided a method of changing a communication parameter comprising the steps of sending a reconfiguration request for changing said communication parameter from a drifting radio network controller to a serving radio network controller and in response to said request releasing and re-establishing channels of user equipment associated with said serving radio network controller using a different communication parameter.

According to another aspect in the present invention, there is provided a communication system comprising a drifting radio network controller and a serving radio network controller, said drifting radio network controller arranged to send a reconfiguration request for changing a communication parameter to said serving radio network controller and said serving radio network controller arranged in response to said request to release and re-establish channels of user equipment associated with said serving radio network controller using a different communication parameter.

According to another aspect in the present invention, there is provided a drifting radio network controller arranged to send a communication parameter reconfiguration request to said serving radio network controller.

According to another aspect in the present invention, there is provided a serving radio network controller arranged to receive a communication parameter reconfiguration request from a drifting radio network controller and in response to said request to release and re-establish channels of user equipment associated with said serving radio network controller.

According to another aspect in the present invention, there is provided a method of communication comprising the steps of determining if at least one user equipment in an area is associated with a plurality of radio network controllers; causing said user equipment to undergo a relocation procedure for those user equipment associated with a plurality of radio network controllers and changing a communication parameter associated with communication between said user equipment and a radio network controller.

According to another aspect in the present invention, there is provided a system of communication comprising a plurality of radio network controllers and at least one user equipment comprising means for determining if at least one user equipment in an area is associated with a plurality of radio network controllers, means for causing said user equipment to undergo a relocation procedure where said user equipment is associated with a plurality of radio network controllers; and means for changing a parameter associated with communication between said user equipment and a radio network controller.

According to another aspect in the present invention, there is provided a drifting radio network controller arranged to send a message to a serving radio network controller to cause said serving radio network controller to trigger a relocation procedure for a user equipment.

According to another aspect in the present invention, there is provided A serving radio network controller arranged to receive a message from a drifting radio network controller requesting a relocation procedure for a user equipment and in response to said message to trigger a relocation procedure for a user equipment so that said user equipment uses a single radio network controller for communication.

According to another aspect in the present invention, there is provided a method of communication comprising the steps of sending a relocation request from a drifting radio network controller to a serving radio network controller, relocating user equipment associated with said serving radio network controller with the radio network controller previously providing a drifting radio network controller function.

### BRIEF DESCRIPTION OF DRAWINGS

For a better understanding of the present invention and as to how the same may be carried into effect, reference will now be made by way of example to the accompanying drawings in which:

FIG. 1 shows a first signalling flow in a first known scenario;

FIG. 2 shows the signalling flow in a second known scenario;

FIGS. 3a to d show a signalling flow in a first embodiment of the present invention;

FIGS. 4a and 4b show a signalling flow in a second embodiment of the present invention;

FIGS. 5a and 5b show a signalling flow in a third embodiment of the present invention; and

FIG. 6 shows a system in which embodiments of the present invention can be incorporated.

### DETAILED DESCRIPTION OF PREFERRED EMBODIMENTS OF THE INVENTION

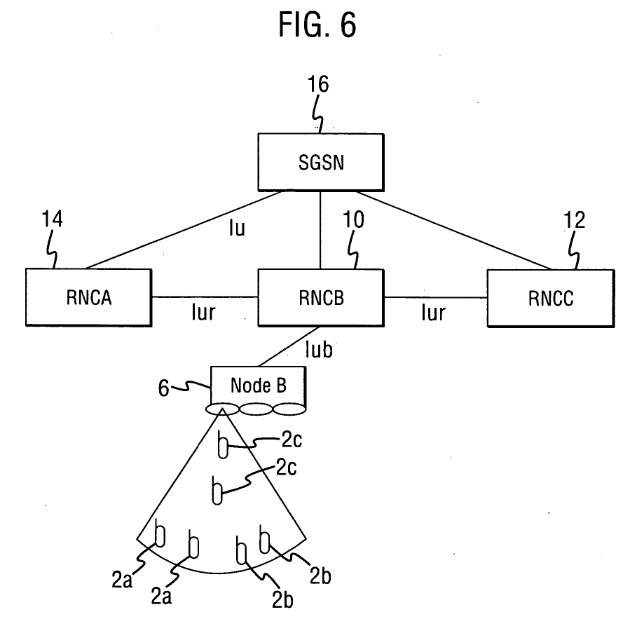

Reference is made to FIG. 6 which shows part of the system in which embodiments of the present invention can be incorporated. User equipment 2 is shown which is arranged to communicate via an air or radio interface with a base transceiver station 6. The base transceiver station 6 is sometimes referred to as Node B.

Node B 6 is generally one of a plurality of Node Bs. The Node B 6 is controlled via a Iub interface by an RNC 10. This RNC is referred to as RNC B. RNC B 10 is connected to a further two RNCs, RNC A 14 and RNC C 12. The connections between the RNCs are via Iur interfaces.

One of these RNCs is a SRNC. This is the RNC which connects to CN core network via an Iu interface and controls RRC protocol to the UE user equipment. The main function is mobility management and forwarding the information from UE via RRC and CN via RANAP to DRNC (Drifting RNC).

The DRNC is the RNC which connects to the SRNC via the Iur interface.

The CRNC is the RNC which mainly takes cares of Call Admission Control, since the RNC knows the resources in cells under the RNC. If the UE is connected to SRNC without the Iur, the SRNC and CRNC for the UE is same. In case there is a connection over the Iur, the DRNC and CRNC for the UE is same.

Either the SRNC or the DRNC is always CRNC. If the DRNC is present, then the DRNC will be the CRNC.

In the embodiment illustrated in FIG. 6, the SRNC for the user equipment 2a is RNC A 14. The DRNC connected via Iur with the SRNC for the equipment 2a is RNC B 10.

The user equipment 2b has RNC B 10 as its serving RNC. Finally, the user equipment marked 2c will have RNCC 12 as its serving RNC. For user equipment 2c, the RNC B 10 will be the drifting/controlling RNC. Thus in one cell, different user equipment will be served by different RNCs.

Each of the RNCs is connected via an Iu interface to a SGSN serving GPRS (general packet radio service) support node 16. The node B and RNCs form part of the radio access network whilst the SGSN 16 forms part of the core network.

Embodiments of the present invention provide five different solutions to the problems described in relation to the prior art. Embodiments of the present invention are particularly concerned where the drifting RNC is the controlling RNC and there is a different serving RNC.

In solution 1, the controlling RNC is completely inhibited from reconfiguring the scrambling code used for the HSDPA when there are user equipment having an ongoing HSDPA transmission in the cell. In this embodiment the CRNC is the same as the DRNC.

In this solution, the drifting RNC will not ask the SRNC to reconfigure the scrambling code used for the HSDPA in the cell that belongs to the DRNS (Drifting radio network subsystem), since the C/DRNC is not able to reconfigure the scrambling code. Thus the C/DRNC is inhibited from reconfiguring the scrambling code. Therefore, in no case does the DRNC request the SRNC to reconfigure the scrambling code.

Where the Serving RNC is the controlling RNC, the scrambling code can not be reconfigured.

In a second embodiment of the present invention, the DRNC is inhibited from reconfiguring the scrambling code used for HSDPA when there are user equipment via the Iur interface having an ongoing HSDPA transmission in the cell.

The second embodiment thus inhibits the DRNC from reconfiguring the scrambling code for HSDPA in case there are UE are connected to the SRNC over Iur. Therefore, in no case does the DRNC request the SRNC to reconfigure the scrambling code.

The difference is in case there are no UE over Iur,(i.e. SRNC for all UEs in the cell is CRNC), the CRNC can change the scrambling code.

In this solution, there will be no case that the DRNC/CRNC asks the SRNC to reconfigure the scrambling code used for the HSDPA in the cell belonging to the DRNS since the DRNC is not able to reconfigure the scrambling code.

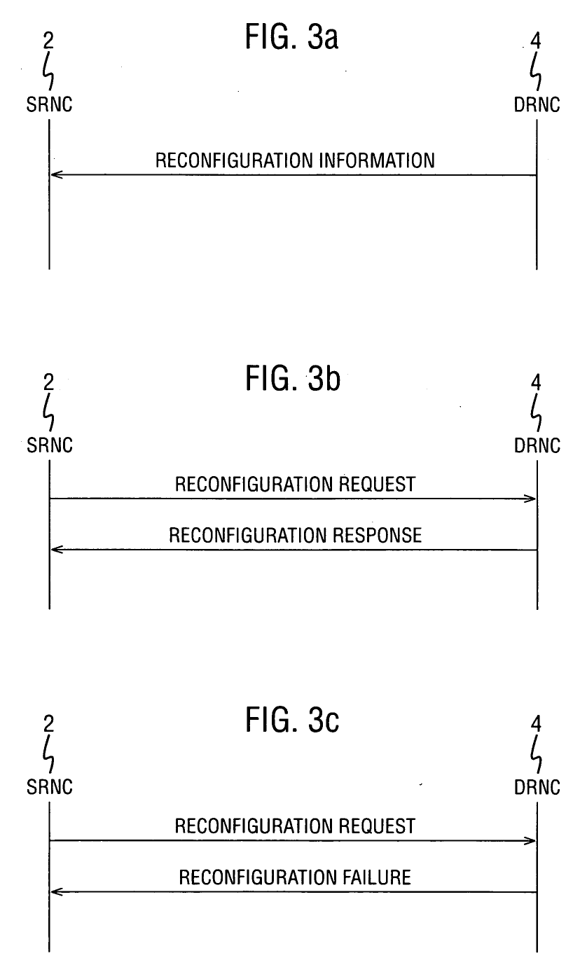

Reference is now made to FIG. 3 which shows a third embodiment of the present invention. This introduces two new RNSAP procedures.

The first procedure is the RECONFIGURATION INFORMATION procedure which is illustrated schematically in FIG. 3a. This contains the C-ID and the scrambling code the D/CRNC wants to change. This is the procedure used by the DRNC 4 to inform the SRNC about the need to reconfigure the scrambling code used for the HSDPA in the cell which belongs to the DRNC.

The second RNSAP procedure is illustrated schematically in FIGS. 3b and 3c. This is the procedure used by the SRNC to request the configuration of the scrambling code used for the HSDPA in the cell which belongs to the DRNC. In other words, the SRNC 2 sends a REFCONFIGURATION REQUEST, requesting reconfiguration of the scrambling code, to the DRNC. This optionally contains the C-ID (Cell Identity) and scrambling code that the SRNC requests the DRNC to change. The DRNC replies with a RECONFIGURATION RESPONSE which includes the CFN when the reconfiguration will be activated. This will contain the CFN corresponding to the SFN that is set by the DRNC in the NBAP message.

FIG. 3c shows the reconfiguration request procedure in the case where the RECONFIGURATION REQUEST sent from the SRNC 2 to the DRNC 4 is unsuccessful. In this scenario, the DRNC 4 will reply with a RECONFIGURATION FAILURE message.

Reference is now made to FIG. 3d which shows a signalling flow incorporating the messages shown in FIGS. 3a to c.

In step A1, RECONFIGURATION INFORMATION is sent from the DRNC 4 to the SRNC 2.

In step A2, the SRNC 2 replies with a RECONFIUGRATION REQUEST to the DRNC 4.

Steps A3 and steps A4 correspond to steps S3 and S4 and will not be described in further detail.

In step A5, the DRNC 4 will reply with a RECONFIGURATION RESPONSE to the SRNC 2 which will contain the SFN which indicates when the scrambling code change will be activated.

Steps A6, A7 and A8 correspond respectively to steps S7, s7 and s9 and therefore will not be described in further detail.

This avoids the problems set out with the prior art.

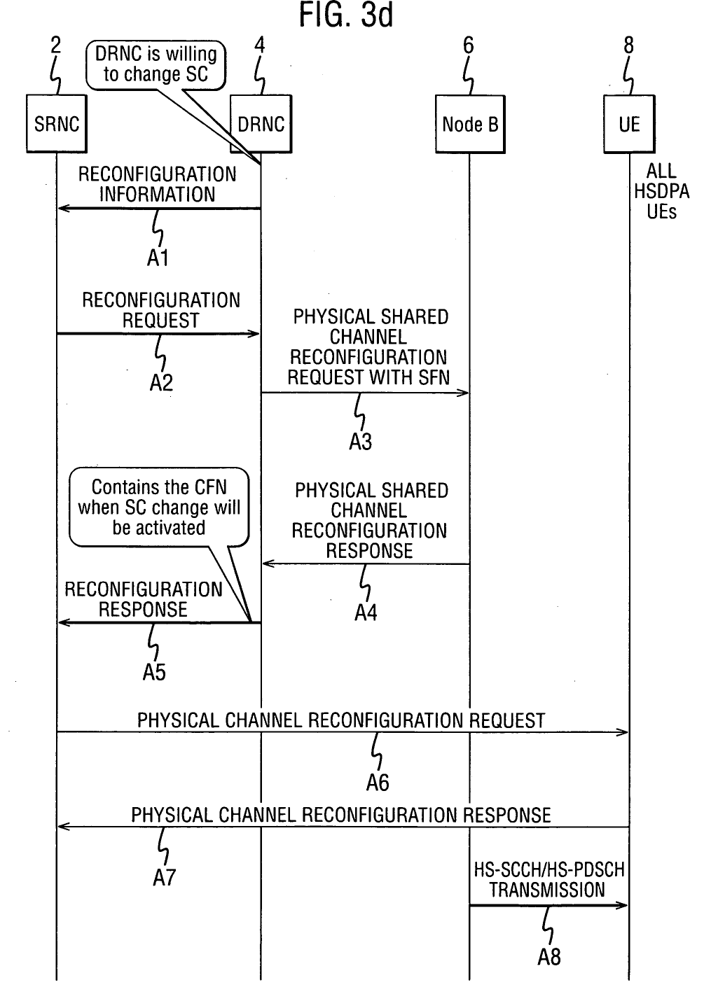

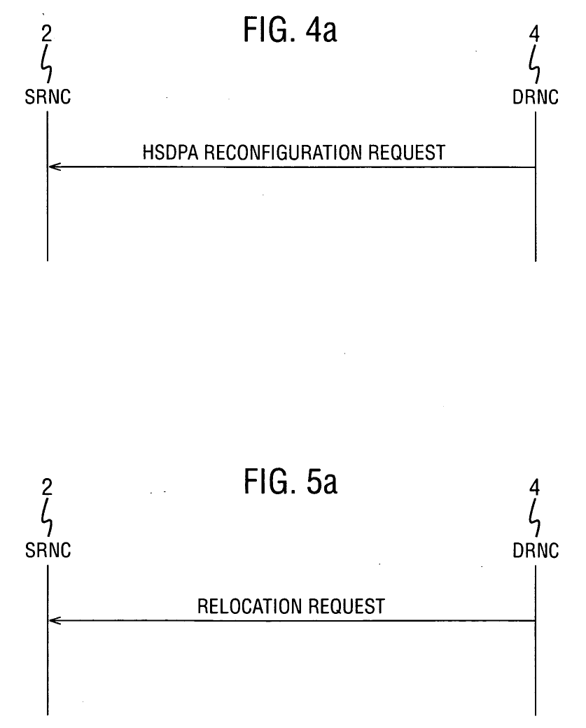

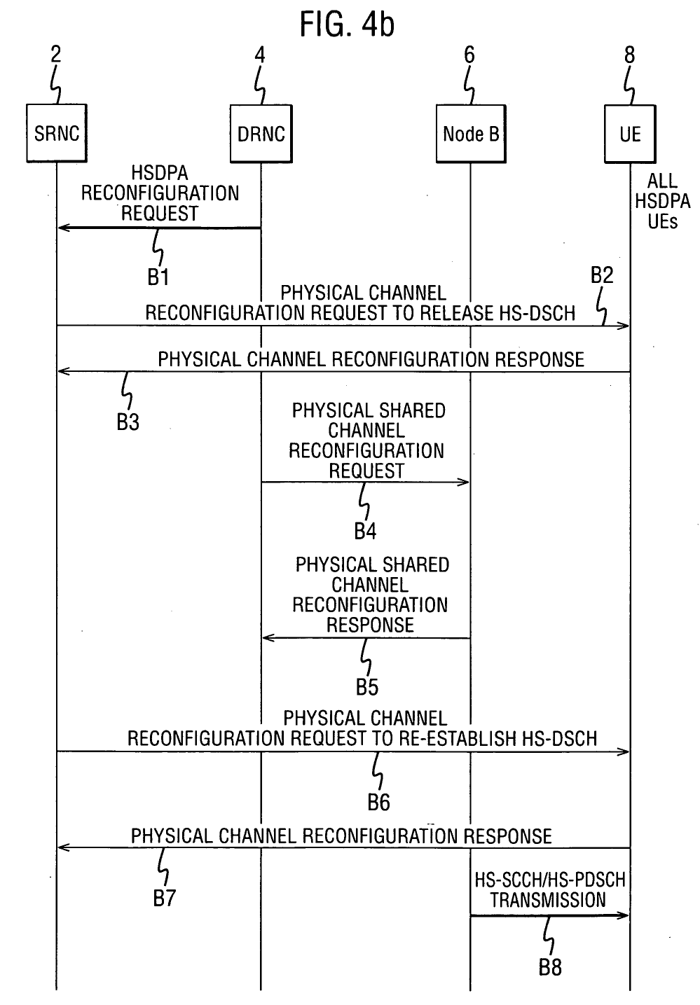

Reference is now made to FIG. 4a and 4b which illustrate a fourth embodiment of the invention. This introduces a new RNSAP global procedure or a new type of procedure for enabling the DRNC to request the SRNC to release and re-establish HSDPA channels of all the user equipment in the cell belonging to the DRNC. This is illustrated in FIG. 4a where the DRNC 4 sends a HSDPA RECONFIGURATION REQUEST to the SRNC 2. This includes the C-ID that the DRNC wants to change the Scrambling Code used in the cell.

With this procedure, it is possible to execute reconfiguration of the scrambling codes used for the HSDPA even in those cases where two RNCs are involved in the HSDPA transmission in the cell. This is because the procedure makes it possible that the DRNC can request the SRNC to release the HSDPA channel of all the user equipment that are involved in the HSDPA transmission and re-establish HSDPA channels which use reconfigured scrambling codes for the user equipment in the cell.

This has the advantage that the DRNC is able to reconfigure the scrambling code for HSDPA.

Reference is now made to FIG. 4b which shows the signal flow using this message.

In step B1, the DRNC 4 sends the HSDPA RECONFIGURATION REQUEST discussed in relation to FIG. 4a to the SRNC 2.

In step B2, the SRNC 2 sends a PHYSICAL CHANNEL RECONFIGURATION REQUEST to release the HS-DSCH.

The user equipment 8 sends a response in step B3 with a PHYSICAL CHANNEL RECONFIGURATION RESPONSE.

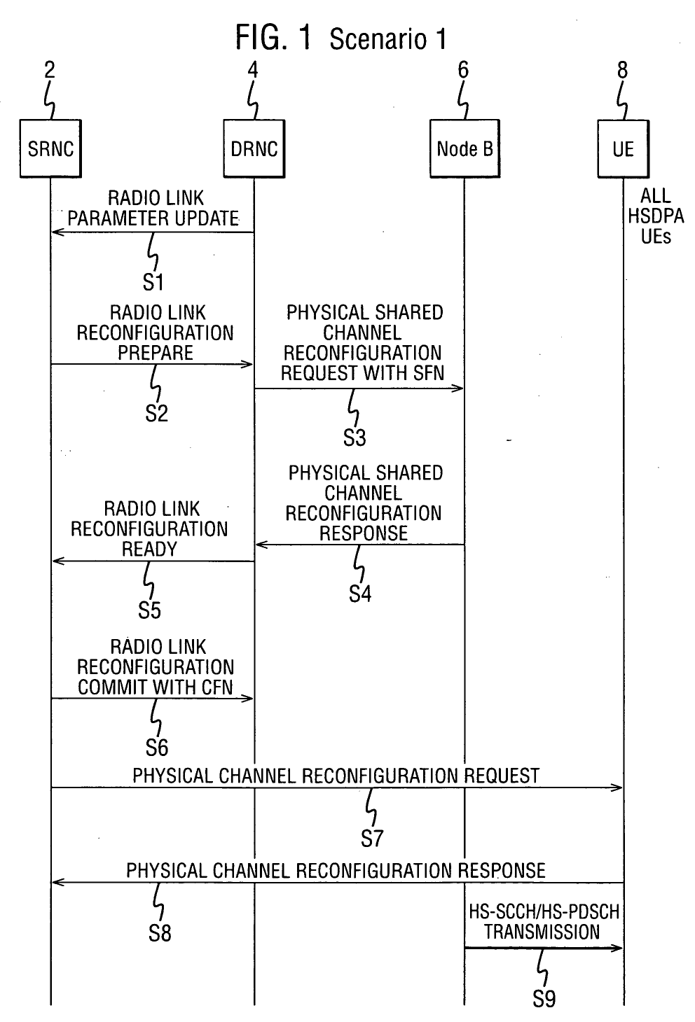

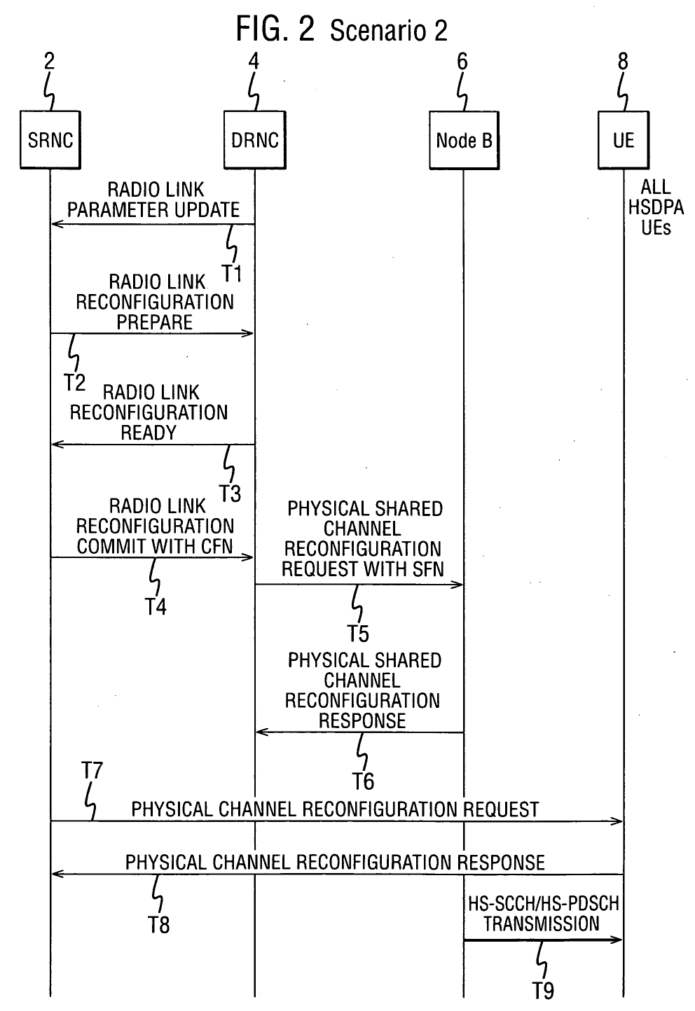

It should be appreciated that steps B2 and B3 correspond generally to steps S7 and S8 of FIG. 1.

Steps B4 and B5 correspond generally to steps S3 and S4 of FIG. 1.

In step B6 the SRNC sends a PHYSICAL CHANNEL RECONFIGURATION REQUEST to re-establish the HS-DSCH. This is sent to the user equipment.

In a step B7, the user equipment responds with a PHYSICAL CHANNEL RECONFIGURATION RESPONSE.

Step B8 corresponds generally to step S9.

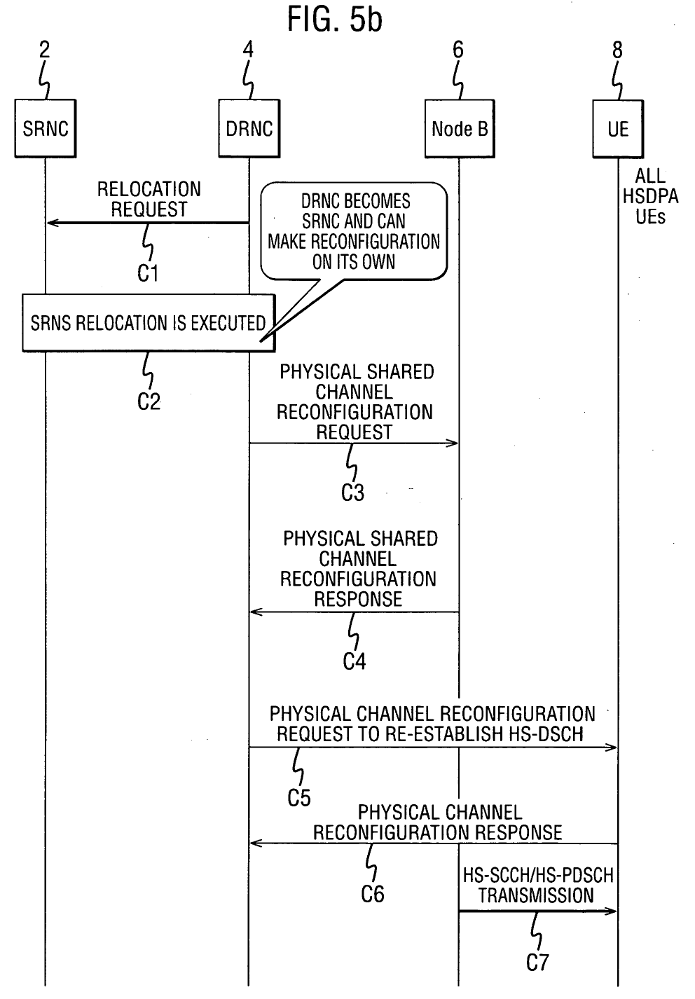

Reference is now made to FIGS. 5a and 5b which show a fifth embodiment of the present invention. In this embodiment, a new RNSAP DCH procedure is introduced for enabling the DRNC to request the SRNC to execute SRNS relocation thus the S/CRNC (not the DRNC) can reconfigure the scrambling code for the cell without needing to send any messages for reconfiguring the scrambling code between RNCs via the Iur interface.

For the inter-RNS(RNC area) mobility(UE moves to neighbouring RNC area), SRNS Relocation enables the Inter-RNC mobility by switching Iu from SRNC to DRNC. After relocation, the DRNC becomes SRNC for the user equipment.

This procedure is thus used by the DRNC to order the SRNC to trigger SRNS Relocation procedure for the user equipment. This is illustrated schematically in FIG. 5A which shows the DRNC 4 sending a RELOCATION REQUEST to the SRNC 2. This includes the C-ID that the DRNC wants to change the Scrambling Code used in the cell.

Because of this procedure, it will now be possible to execute reconfiguration of the scrambling code used for the HSDPA even where there are user equipment where two or more RNCs are involved in the HSDPA transmission in the cell. This is because this procedure makes it possible that the DRNC can request the SRNC to trigger SRNS relocation for user equipment that the HSDPA transmission is executed over Iur. In other words, the configuration is changed so that there is no user equipment associated with the HSDPA transmission which is executed over Iur in the cell.

Reference is now made to FIG. 5b which shows signalling using the new message illustrated in FIG. 5a in more detail.

In step C1, the DRNC 4 sends to the SRNC 2 the RELOCATION REQUEST.

In step C2 SRNS relocation is executed. The DRNC becomes the SRNC and can deal with the reconfiguration on its own.

Steps C3 and C4 correspond to steps S3 and S4.

Steps C5 and C6 correspond to steps S7 and S7 but instead are between the new SRNC (previously DRNC 4) and the user equipment.

Step C7 corresponds to step S9.

Some of the advantages of the various embodiments will now be described:

For the first embodiment, the advantage is that the required change to the specification is small.

There is a similar advantage to the second embodiment.

The third embodiment has the advantage that the number of required messages to be sent for the reconfiguration of the scrambling code is small since the message is sent per cell and not per user equipment. This makes the feature possible without releasing the HSDPA channels in the cell.

The fourth embodiment has the advantage that the number of required messages to be sent for the reconfiguration of the scrambling code is small since the message is sent per cell and not per user equipment.

The fifth solution has the advantage of making the feature possible without releasing the HSDPA channels in the cell.

It should be appreciated that embodiments of the present invention can be used with other communication parameters other than the scrambling code. Embodiments of the invention can be used for example to change radio link parameters or the like.

1. A communications system comprising:
a plurality of radio network controllers, at least one of said radio network controllers providing a controlling radio network controller function, wherein said at least one radio network controller is prohibited from causing reconfiguration of a communication parameter between user equipment and said at least one radio network controller.

2. The system as claimed in claim 1, wherein said communication parameter comprises a scrambling code.

3. The system as claimed in claim 1, wherein said communication parameter is used for high speed downlink packet access.

4. The system as claimed in claim 1, wherein said at least one radio network controller is configured to be prohibited from causing reconfiguration of said communication parameter if there is an ongoing transmission.

5. The system as claimed in claim 1, wherein said at least one radio network controller provides one of a drifting radio network controller function and a serving radio network controller function.

6. The communications system as claimed in claim 1, wherein a radio network controller providing a serving radio network controller function is configured to cause reconfiguration of said communication parameter.

7. The communications system as claimed in claim 6, wherein said serving radio network controller function is only configured to cause reconfiguration of said communication parameter if said serving radio network controller also provides said controlling radio network controller function.

8. A radio network providing a controlling radio network controller function, wherein a radio network controller acting as a controlling radio network controller is prohibited from causing reconfiguration of a communication parameter between user equipment and said controlling radio network controller.

9. A method of communication in a system comprising a plurality of radio network controllers, at least one of said radio network controllers providing a controlling radio network controller function, said method comprising the step of:
prohibiting said at least one radio network controller from causing reconfiguration of a communication parameter between user equipment and said at least one radio network controller.

10. A method of changing a communication parameter comprising the steps of:
sending a message from a drifting radio network controller to a serving radio network controller of a requirement to change a communication parameter; and
sending a request from said serving radio network controller to said drifting radio network controller requesting the drifting radio network controller change said communication parameter.

11. The method as claimed in claim 10, comprising the step of changing said communication parameter.

12. The method as claimed in claim 11, wherein said step of changing said communication parameter is controlled by said serving radio network controller.

13. The method as claimed in claim 10, wherein said step of sending a message further comprises sending a message comprising information on said communication parameter to be changed.

14. The method as claimed in claim 10, comprising the step of sending, from said drifting radio network controller to the serving radio network controller, a response containing information as to when a change will be activated.

15. The method as claimed in claim 14, wherein said step of sending a response comprises sending a response containing information comprising a connection frame number (CFN).

16. The method as claimed in claim 10, comprising the step of sending a failure message from the serving radio network controller to the drifting radio network controller if changing of said communication parameter is to be prevented.

17. The method as claimed in claim 10, wherein said step of sending a message comprises sending a message of a requirement to change a communication parameter comprising a scrambling code.

18. The method as claimed in claim 10, wherein said communication parameter is used for high speed downlink packet access.

19. The method as claimed in claim 10, wherein said step of sending a message comprises sending a message comprising at least one of cell identity information and communication parameter information to be changed.

20. The method as claimed in claim 10, wherein said step of sending a request comprises sending a request comprising at least one of cell identity information and communication parameter information to be changed.

21. A communication system comprising a drifting radio network controller and a serving radio network controller, said drifting radio network controller being configured to send a message to the serving radio network controller of a requirement to change a communication parameter, and said serving radio network controller being configured to send a request to said drifting radio network controller requesting the drifting radio network controller change said communication parameter.

22. A drifting radio network controller configured to send a message to a serving network controller of a requirement to change a communication parameter, and in response to a request from said serving network controller to provide timing information to control timing of the change of said communication parameter.

23. A serving radio network controller being configured to send a request to a drifting radio network controller requesting the drifting radio network controller change a communication parameter and to reconfigure said communication parameter in accordance with timing information received from said drifting radio network controller.

24. A method of changing a communication parameter comprising the steps of:
sending a reconfiguration request for changing said communication parameter from a drifting radio network controller to a serving radio network controller; and
in response to said reconfiguration request, releasing and re-establishing channels of user equipment associated with said serving radio network controller using a different communication parameter.

25. The method as claimed in claim 24, wherein said releasing and re-establishing step is carried out for all user equipment associated with a drifting radio network controller.

26. The method as claimed in claim 24, wherein said step of sending comprises sending the reconfiguration request for changing a communication parameter comprising a scrambling code.

27. The method as claimed in claim 24, wherein said step of sending comprises sending the reconfiguration request for changing a communication parameter which is used for high speed downlink packet access.

28. The method as claimed in claim 24, wherein said step of sending comprises sending the reconfiguration request comprising at least one of cell identity information and communication parameter information to be changed.

29. A communication system comprising a drifting radio network controller and a serving radio network controller, said drifting radio network controller configured to send a reconfiguration request for changing a communication parameter to said serving radio network controller, and said serving radio network controller configured, in response to said reconfiguration request, to release and re-establish channels of user equipment associated with said serving radio network controller using a different communication parameter.

30. A drifting radio network controller configured to send a communication parameter reconfiguration request to a serving radio network controller.

31. A serving radio network controller configured to receive a communication parameter reconfiguration request from a drifting radio network controller, and in response to said reconfiguration request to release and re-establish channels of user equipment associated with said serving radio network controller.

32. A method of communication, said method comprising the steps of:
determining if at least one user equipment in an area is associated with a plurality of radio network controllers;
causing said at least one user equipment to undergo a relocation procedure for the at least one user equipment associated with a plurality of radio network controllers; and
changing a communication parameter associated with communication between said at least one user equipment and a radio network controller.

33. The method as claimed in claim 32, wherein said step of changing comprises changing a communication parameter comprising a scrambling code.

34. The method as claimed in claim 32, wherein said step of changing comprises changing a communication parameter that is used for high speed downlink packet access.

35. The method as claimed in claim 32, wherein said causing step comprises sending a relocation request from a drifting radio network controller to a serving radio network controller.

36. The method as claimed in claim 35, wherein said relocation request comprises at least one of cell identity information and communication parameter information to be changed.

37. The method as claimed in claim 35, comprising the step of, in response to said relocation request, carrying out a serving radio network subsystem (SRNS) relocation procedure for a user equipment.

38. A system of communication comprising a plurality of radio network controllers and at least one user equipment, said system comprising:
determining means for determining if at least one user equipment in an area is associated with a plurality of radio network controllers;
causing means for causing said at least one user equipment to undergo a relocation procedure where said at least one user equipment is associated with a plurality of radio network controllers; and
changing means for changing a parameter associated with communication between said at least one user equipment and a radio network controller.

39. A drifting radio network controller configured to perform the step of: sending a message to a serving radio network controller to cause said serving radio network controller to trigger a relocation procedure for a user equipment.

40. A serving radio network controller configured to perform the steps of:
receiving a message from a drifting radio network controller requesting a relocation procedure for a user equipment; and
in response to said message, triggering the relocation procedure for the user equipment so that said user equipment uses a single radio network controller for communication.

41. A method of communication, said method comprising the steps of:
sending a relocation request from a drifting radio network controller to a serving radio network controller;
relocating user equipment associated with said serving radio network controller with a radio network controller previously providing a drifting radio network controller function.
